(19) United States
(12) Patent Application Publication
(10) Pub. No.: US 2003/0232161 A1
(43) Pub. Date: Dec. 18, 2003

(54) Poly-woven laminated paper bag with window

(76) Inventors: Paul Lin, Lake Oswego, OR (US); Yumming Pang, Portland, OR (US); James Staub, Aloha, OR (US)

Correspondence Address: IPSOLON LLP, 805 SW BROADWAY, #2740, PORTLAND, OR, 97205, US

(21) Appl. No.: 10/173,458

(22) Filed: Jun. 14, 2002

(51) Int. Cl. B32B 1/02

(52) U.S. Cl. 428/34.3

(57) ABSTRACT

A bag has a paper layer with a die cut window formed therein, and a second layer of poly-woven scrim that is translucent so that material contained within the bag may be visually inspected through the window. The die cut window is registered relative to the bag ends and any printing on the bag.

### FIELD OF THE INVENTION

This invention relates to multiwall bags configured for containing bulk quantities of materials, and more specifically, to such a bag having a paper outer layer and a woven inner layer, and a die cut opening in the paper layer that defines a window to allow the contents of the bag to be visually inspected.

### BACKGROUND

Bulk quantities of materials are often packaged in multi-layer bags, and not surprisingly, there are numerous styles of bags known in the art. One type of bag has an outer layer of paper such as a kraft paper, and an inner layer of a poly-woven fabric laminated to the paper. One common kind of woven fabric used in such bags is a polypropylene material. Another is a polyethylene woven material. This kind of a bag is typically manufactured from roll stock paper-typically a standard kraft paper, and roll stock woven poly-woven material, often called “scrim.” The scrim layer provides a strong, durable liner for the bag.

Although there are several processes according to which the bags may be made, briefly described, the bags are fabricated by laminating or gluing the polypropylene fabric to the layer of paper to form an elongated continuous flattened blank, or web. The blank is formed into a tube by joining opposite lateral side edges at longitudinally extending seams, and by then cutting the tube into the desired bag lengths with rotating knives. One end of the tube is the closed with the desired end type, for example by stitching or heat sealing one end of the tube to define a closed bottom, leaving the opposite end open for filling and sealing by the end user. Any common type of closure may be used on either end of the bag, including as noted sewn ends, but also including valve ends, pinch ends and block bottom closures. The sides of the bag may be gusseted or flat, depending upon the user's needs and specifications.

Other process steps may be used as well in manufacturing such bags, for example, printing the outer surface of paper layer with various information such as the identity of the product that will be held in the bag, the manufacturer of the product, and the net weight of the bag, etc. One advantage of bags having a paper outer layer is that these bags are well suited to stacking; the paper tends not to slip when the bags are stacked atop one another, and large stacks of bags therefore tend to be relatively more stable than, for example, stacks of bags having plastic outer layers.

One feature that many bag customers want is a window in the bag that allows the contents of the bag to be viewed and inspected by the end user. Thus, and by way of example, when a bulk bag that contains rice includes a window, the end user is able to inspect the product prior to making a purchase.

Although there are known methods of forming a window in a bulk materials bag, none of the known methods produces a bag that is as reliable or as strong as needed. One method involves making a die cut window in the paper layer and gluing a “patch” over the window on the surface of the paper that will be form the interior of the bag. The patch is a clear or translucent material that is fabricated from one of several materials, selected according to the specifics of the bag type. While this kind of a window bag allows the end user to see the product contained in the bag, the bag is inherently weaker than a non-window bag because the integrity of both the paper layer is disturbed, and the plastic patch typically is not as strong as the paper. The patch thus represents a relatively weak portion of the bag that can rupture or leak during handling and transport.

A completely different type of bag that allows the user to view the contents held in the bag has a scrim layer that is relatively translucent. The scrim is laminated (for example, with glue or resin, or heat treatment) to an outer layer fabricated from a clear or translucent film, such as ethyl vinyl acetate (EVA). The EVA layer is amenable to high quality printing with, for example, colored graphics and the like. Non-printed areas of the EVA layer may be utilized as windows. Bags having an EVA film outer layer tend, however, to form less stable stacks compared to paper bags, since the EVA tends to slide more easily over adjacent bags than paper-paper contact between adjacent EVA bags.

Accordingly, in view of the shortcomings inherent in conventional bags such as those just described, there is an opportunity to supply a window bag that has all of the advantages of conventional bags, yet avoids the shortcomings.

### SUMMARY OF THE INVENTION

The illustrated embodiment of the bag of the present invention is a multi-layer bag having a layer of translucent poly-woven scrim, and a paper layer that includes a die cut opening that defines a window when the two layers are laminated. The two layers are registered relative to one another prior to lamination so that the position of the window is the same on each successive bag.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective view of an illustrated embodiment of the multi-layer window bag according the present invention, the illustrated bag having gusseted sides, a sewn closed bottom and an open top, and showing a quantity of a bulk commodity contained in the bag interior.

FIG. 2 is a cross sectional view taken along the lines 2-2 of FIG. 1, with the bulk commodity removed.

FIG. 3 is detail view taken at the close up circle 3 of FIG. 2.

FIG. 4 is a plan view of a multi-layer blank of material that has been formed into a tube but prior to the blank being cut to form individual bags.

FIG. 5 is a schematic side elevation view of one illustrated embodiment of a processing line for forming the multi-layer blank from which the bag of FIG. 1 is formed.

FIG. 6 is a schematic side elevation view of another illustrated embodiment of a processing line for forming a multi-layer blank or web from which a bag according to the invention may be formed.

FIG. 7 is a schematic perspective view of another illustrated embodiment of a processing line for forming the multi-layer web from which the bag of FIG. 1 is formed.

FIG. 8 is a schematic side elevation view of yet another illustrated embodiment of a processing line showing application of a coating material to the web formed according to the process shown in FIG. 5.

FIG. 9 is a cross sectional view of an alternate embodiment of the multi-layer window bag according to the present invention, taken along lines equivalent of the lines 2-2 of FIG. 1, but showing a three-layer bag.

FIG. 10 is a detail view of the bag of FIG. 9 taken at the close up circle 10 of FIG. 9.

FIG. 11 is a schematic side elevation view of one illustrated embodiment of a processing line for forming the multi-layer web from which the bag of FIG. 9 is formed.

FIG. 12 is a schematic perspective view of another illustrated embodiment of a processing line for forming the multi-layer web from which the bag of FIG. 9 is formed.

FIG. 13. is a schematic perspective view of another illustrated embodiment of a processing line for forming the multi-layer web from which the bag of FIG. 9 may be formed.

### DETAILED DESCRIPTION OF THE PREFERRED EMBODIMENTS

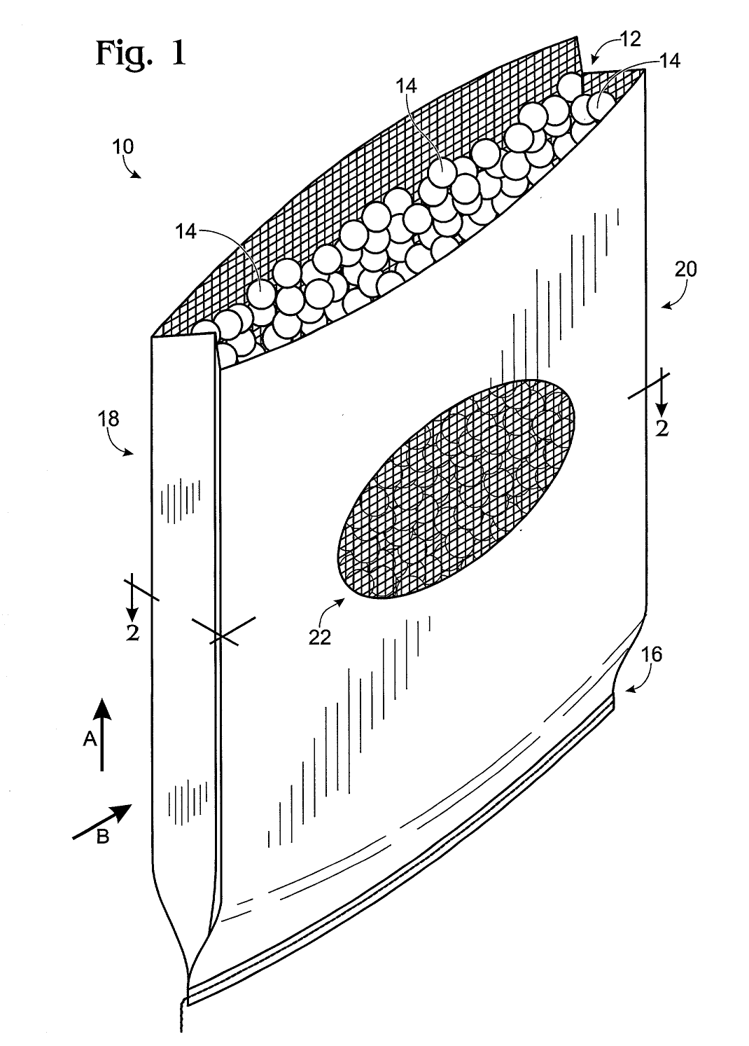

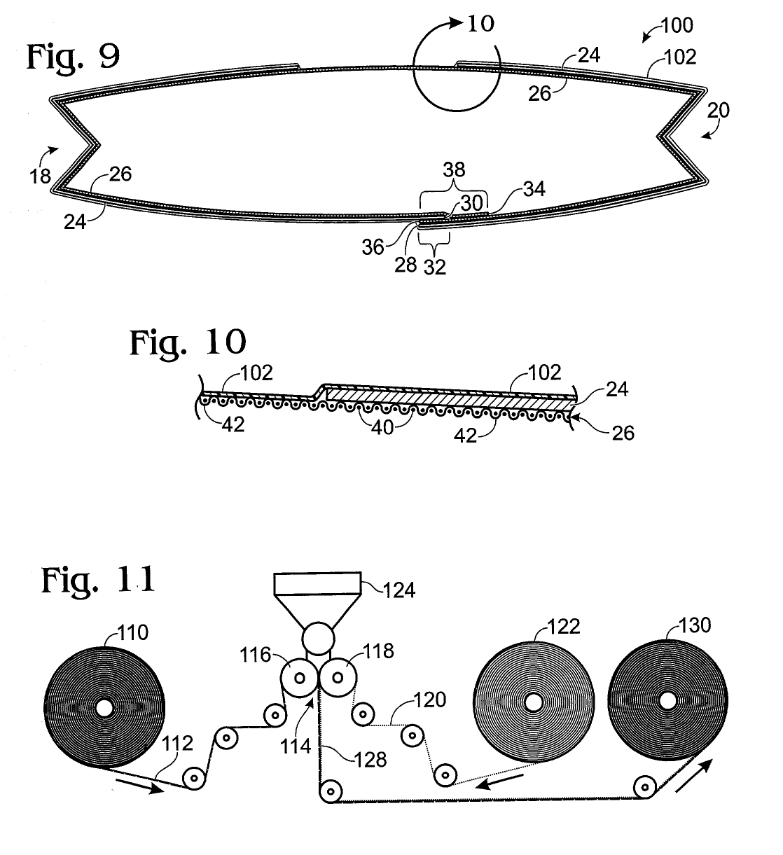

One illustrated embodiment of the present invention is shown in FIGS. 1 through 3. Another illustrated embodiment is shown in FIGS. 9 and 10. With reference to FIG. 1, bag 10 is shown with the first end 12 open to illustrate a bulk commodity 14 contained in the bag. Bulk commodity 14 is illustrated generally as comprising some generic bulk material, and it will be understood that bag 10 is designed to contain any number of bulk commodities, such as food products and other agricultural products and innumerable other items. The end of bag 10 that is opposite first end 12 is referenced generally with number 16. For ease of reference first end 12 is referred to as the top end of bag 10, and opposite end is referred to as bottom end 16. Bottom end 16 is illustrated as being closed with a conventional sewn closure. After filling, top end 12 also would of course be closed in a conventional manner, for example with a sewn closure or valve closure. The first and second lateral side edges of bag 10 are designated with reference numbers 18 and 20, respectively, and are illustrated as being defined with conventional gussets.

It is to be appreciated that while the invention is illustrated and described as being embodied in a specific type of bag that has gusseted sides, and a sewn closure on the bottom end, the invention as claimed is applicable to multi-layer bags having other side and end configurations. For example, the invention is applicable to bags having flat side edges and other types of sides, and any type of end closures, including sewn ends, sealed ends, valve ends, pinch bottom ends, etc. As such, the specific bag configuration described herein illustrates the invention only and is not intended as a limitation to the claims appended hereto.

A window 22 is formed in the outer layer of bag 10, as described in detail below. Window 22 allows for commodity 14 to be viewed through the window.

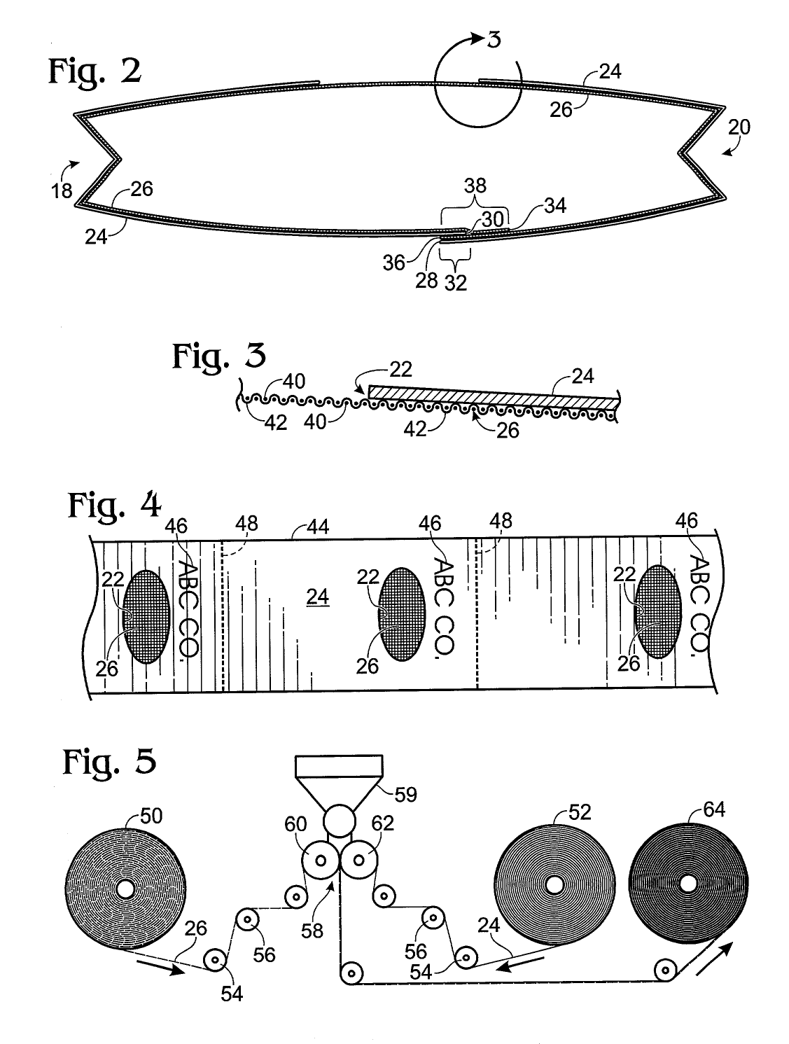

With reference now to FIG. 2, bag 10 is shown as comprising two layers or plies, an outermost layer 24 and an inner layer 26. Outermost layer 24 (also referred to herein as paper layer 24) is typically a conventional and commercially available kraft paper of suitable weight that is supplied in bulk rolls.

Inner layer 26 comprises a poly-woven fabric, sometimes referred to herein as scrim layer 26. There are numerous commercially available materials available for use in scrim layer 26, but in all instances the selected material will have enough translucency to allow the commodity 14 contained in the bag interior to be viewed and inspected through window 22. Stated otherwise, the material selected for inner layer 26 has sufficient transparency that material contained within the bag may be seen through window 22 with sufficient clarity that a viewer may visually discern and inspect the contents with reasonable clarity. One preferred scrim layer 26 is a woven polypropylene fabric. Another preferred scrim layer 26 is a woven polyethylene fabric. As used herein, “poly-woven fabric” or scrim layer 26 refers to polypropylene and polyethylene fabrics, and other woven fabrics of equivalent functionality. Scrim layer 26 preferably has the desired translucency and a fabric weight in the range of about 500 to 1200 denier, and a weave (referring to the number of weft and warp tapes per inch) within the range of about 4 by 4 to about 15 by 15. A more preferred scrim layer is a poly-woven fabric having a weight of about 800 to 900 denier and a weave of about 8 by 8. However, so long as the desired translucency is maintained, the weight of the fabric and the width of the tape may vary widely from the preferred ranges stated. Inner layer 26 is bonded to outer layer 24 as described below.

With reference now to FIGS. 1 and 3, it may be seen that the woven fibers that define the fabric of inner layer 26 run generally parallel to the longitudinal axis of bag 10 and generally transverse to the longitudinal axis of bag 10. Thus, for reference purposes, a bag axis is defined as the axis extending in the direction of arrow A in FIG. 1—that is, the axis that extends along the longitudinal axis of the formed bag. The cross-bag axis is transverse to the bag axis, and is illustrated with arrow B in FIG. 1. Using conventional terminology, tapes 40 represent warp tapes (running along the bag axis) and tapes 42 represent weft taps (running transverse to the warp tapes).

There are several process steps according to which bag 10 may be fabricated. Outer layer 24 is, as noted, kraft paper that typically is supplied in a roll. FIG. 4 illustrates a section of a continuous tubular blank or web 44 that comprises an outer layer 24 that has plural die cut windows 22 formed therein, each of which is evenly spaced apart from the next adjacent window, and an inner layer 26 of woven fabric that is visible through the windows. While window 22 shown in the drawings is oval in shape, it will be appreciated that the window can be cut in any shape and that more than one window may be cut into the paper layer. Further, as described in greater detail below, window 22 is cut and registered relative to other materials in the bag so that the position of the window on the bag is always in the desired location. Continuing with reference to FIG. 4, the web 44 has been formed into a tube and the outer layer, in most instances, will be preprinted with various labeling indicia 46 (“ABC CO.”), which is repeated at evenly spaced. As detailed below, once the desired layers have been laminated and formed into a tubular web 44, the web is cut in the cross bag direction at appropriate intervals (for example, at dashed lines 48) to define individual bags having open opposite ends. The bottom end is typically then closed with an appropriate closure, leaving the top end open for filling and sealing by the user. It also is to be understood that the top end may be closed with an appropriate closure and sent to the customer for filing through the open bottom end.

When web 44 includes printed indicia, each die cut window 22 is registered relative to the position of indicia 46 so that the window 22 is positioned in the same position on each finished bag. In all cases the window is registered relative to the cut lines (dashed lines 48) so that the window is placed in the same place (relative to the bag top end and bottom end) on each successive bag.

One process for forming bag 10 is shown in FIG. 5 where scrim layer 26 is supplied in a supply roll 50 and the material for outer layer 24 is supplied in a separate supply roll 52. The material in supply roll 52 has already been die cut with windows 22 and has already been printed with indicia 46, if the later is desired. Paper layer 24 and scrim layer 26 are fed around appropriate intermediary rolls such as guide rolls 54 and tensioning rolls 56 into and through a nip 58 defined between pinch rolls 60, 62. As detailed below, one or more of the lateral edges of the two layers may be overlapped, or laterally offset relative to one another in the cross bag direction as they come together in order to facilitate seam formation. Alternately, one of the layers 24 or 26 may be wider than the other layer (in the cross bag direction) to facilitate formation of a seam. As the two layers 24 and 26 enter nip 58 a lamination unit 59 (such as a conventional extrusion head) applies a bonding agent such as a resin between the layers. The resin (not shown) is preferably coated onto substantially the entire facing surfaces between the two layers. The pressure applied between the pinch rolls on layers 24 and 26 bonds the layers together. It will be appreciated that there are numerous apparatus available for applying bonding agents such as resin between layers 24 and 26, including for example extrusion heads, curtain coaters, spray coaters and the like.

After passing through nip 58 the two layer web is either rolled onto a take-up or rewind roll 64 for further processing or is fed directly into the further processing line, namely tube formation and bag cutting, both of which are performed in a conventional manner well known to those of ordinary skill in the art.

As noted above, during formation of the blank from which the finished bag 10 will be formed, one or both of the opposite lateral edges of layers 24 and 26 may be overlapped or laterally stepped or offset relative one another during seam formation. This lateral stepping process is done to facilitate formation of longitudinal seams. There are several ways to form the blank, multi-layer web into a tube by joining opposite edges of the blank in a longitudinal seam. One method is illustrated in the cross sectional illustration of FIG. 2 and is done so that when a tube is formed from the blank the overlapping edges of each layer form a longitudinal seam that has an overlapping portion. Referring specifically to FIG. 2, it may be seen that one lateral edge 28 of outer layer 24 aligns with the adjacent lateral edge 36 of inner layer 26. The coextensive edges 28 and 36 overlap with the opposite lateral edge 30 of the paper layer 24 to define a longitudinal seam 32. However, the opposite lateral edge 34 of inner layer 26 (which in the illustration of FIG. 2 is wider in the cross bag direction than layer 24) overlaps and extends beyond edge 30 of layer 24 and is adhered to the overlapped portion of inner layer 26. The combined overlapping regions define a longitudinal seam 38. Both longitudinal seams 32 and 38 extend in the bag direction. During tube formation, the overlapping portions of the layers are coated with suitable adhesive to bond the seams. As shown in FIG. 2, longitudinal seams 32 and 38 are laterally overlapped. Other seam structures function equally as well as the structure just described.

In some instances the customer may desire a finished bag that has the paper layer on the inside of the bag, and the poly-woven layer on the outside. This is accomplished by forming the tub as described above, but with the paper toward the tube interior. Thus, although the bag of FIG. 1 includes a first layer of paper and a second layer of poly-woven material, the bag may be formed with the first layer either on the inside, or on the outside according to customer preference. Moreover, with a bag that has paper on the inside and the poly-woven scrim on the outside, it may be desirable to add an outer layer of EVA material, which has been preprinted (in the manner described below).

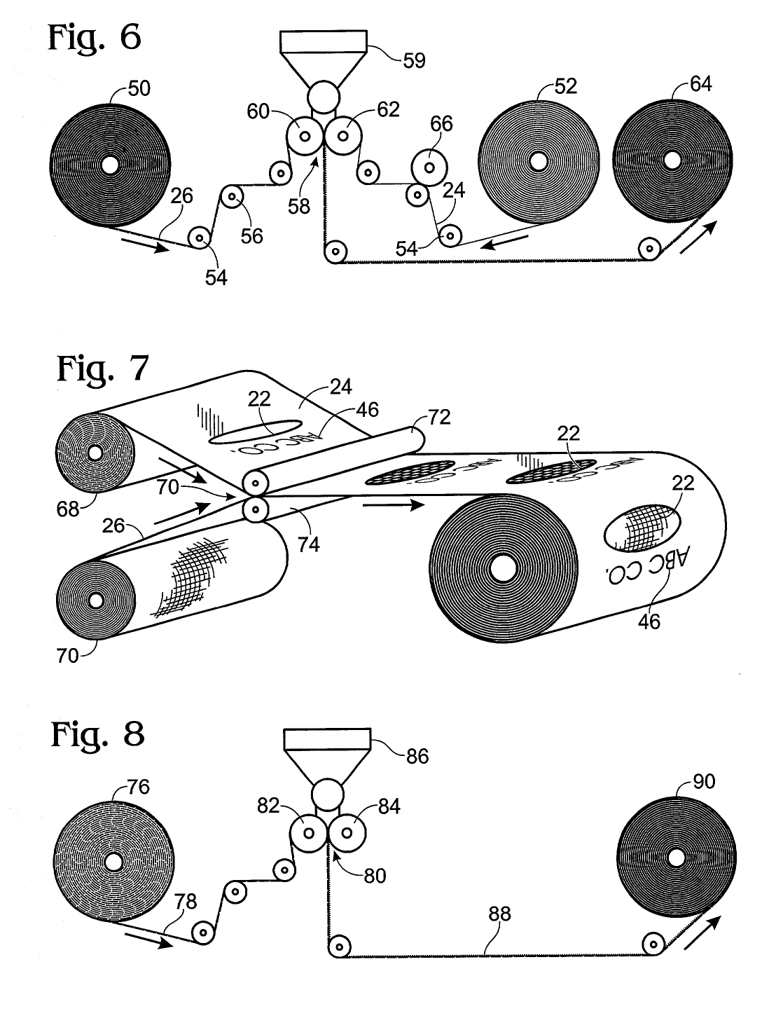

As one alternative to the steps illustrated in FIG. 5, supply roll 52 may be unprinted and without die cut windows. FIG. 6 is similar to the process shown in FIG. 5, except a die cut roll 66 is positioned between supply roll 52 (which in FIG. 6 is a blank web of paper without windows 22 cut therein) and the lamination unit 59. Die cut roll 66 includes a knife blade registered to cut windows 22 in outer layer 24.

Yet another alternative processing line for manufacturing a multi-ply blank web according to the present invention is shown in FIG. 7, where outer layer 24 (preprinted with indicia 46 and precut with windows 22, both of which are registered relative to one another) is supplied from a supply roll 68. Inner woven layer 26 is similarly supplied from a supply roll 70. Inner layer 24 and outer layer 26 are fed through a nip 70 defined between pinch rolls 72, 74 to bond the two layers together. In the illustration of FIG. 7, one or both of the inner layers and outer layers may be pre-coated on the surface that mates with the opposite layer with a suitable adhesive such as a heat-activated resin. In that case the pinch rolls 72 and 74 may be heated to activate the resin and achieve bonding between the two layers. In the illustration of FIG. 7 the woven fabric is not shown through windows 22 in the bonded multi-layer blank that is being wound onto the rewind roll.

FIG. 8 illustrates the addition of a coating layer to the preformed multi-layer blank of web material. Thus, a supply roll 76 of a blank web 78 that has been preformed and comprises an outer layer 24, inner layer 26 and windows 22 (fabricated as described above) is provided. Blank web 78 is fed through a nip 80 between pinch rolls 82, 84. A coating layer is applied to the outer layer of blank web 78 (that is, the layer that will form the outer layer of the finished bag 10—the paper layer) at lamination unit 86, which typically is an extrusion coating head or similar coating unit. The coating typically is a clear resin that provides additional protection for the bag, and may comprise a conventional plastic-type coating selected from numerous compounds well known to those of skill in the art. The coated web 88 is wound onto take up roll 90 for further processing as described above.

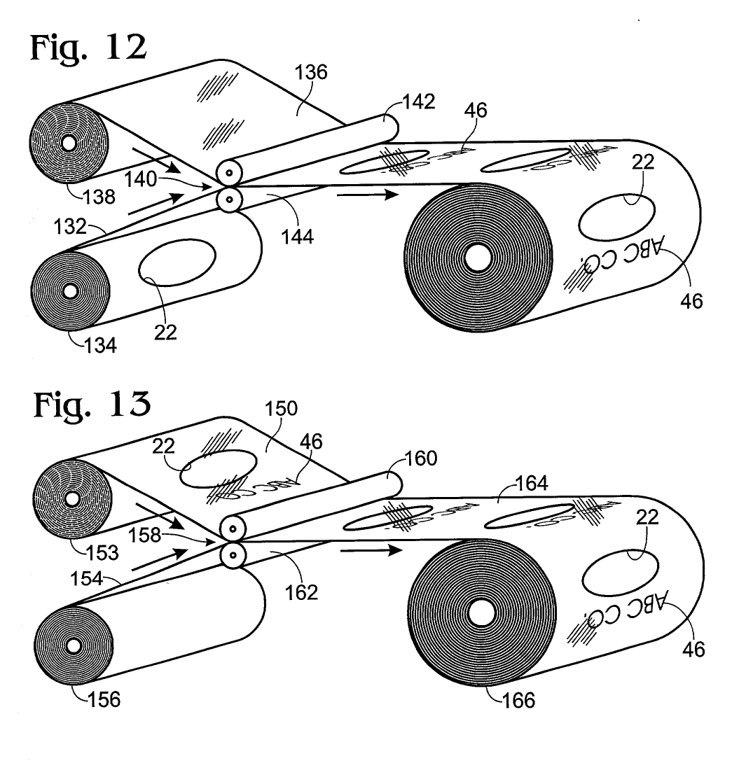

In some instances it is desirable to add yet another layer to the two-layer bag described above to provide added resiliency and other benefits. Such a bag is illustrated in FIGS. 9 and 10, and various processing techniques are shown in FIGS. 11 and 12. Beginning with FIG. 9, bag 100 is identical in structure to bag 10 described above, except in addition to paper layer 24 and inner woven layer 26, an outermost layer 102 has been added. As such, paper layer 24 has become an intermediate layer. Outermost layer 102 comprises a clear layer of a material such as ethyl vinyl acetate (EVA) or oriented polypropylene (OPP). The outer layer provides additional protection for the bag and additional printing options, since materials such as EVA and OPP may be printed with high quality color graphics. Importantly, because EVA and OPP and similar materials are selected to be highly translucent, these materials when applied as an outer layer 102 do not impact the ability to view the contents 14 contained in the bag through window 22. It will be appreciated that printed indicia on outer layer 102 (not shown) must be registered relative to window 22 so that the indicia is always in the same position relative to the window on each finished bag. FIG. 10 illustrates outer layer 102 as it lays adjacent inner layer 26 at window 22 to provide added protection for the window. As with the bag illustrated in FIG. 1, the three-layer bag of FIG. 10 may be manufactured with the paper layer on the interior of the bag, the scrim layer in the middle, and the EVA layer on the outside.

Alternative processing methods for manufacturing the tri-layer bag 100 shown in FIGS. 9 and 10 are shown in FIGS. 11, 12 and 13. It will be appreciated to those of ordinary skill in the art that the same processing variations described above with respect to bag 10 may be applied to processing bag 100. One processing method is illustrated in FIG. 11 where a supply roll 110 of a blank web 112 that has been preformed and comprises an outer paper layer and an inner poly-woven layer, and which includes windows 22 (fabricated as described above) is provided and fed through a nip 114 between rolls 116, 118 where the web 112 is bonded to an outer layer 120 that is supplied from supply roll 122. Outer layer 120 is a clear material such as EVA or OPP as described and is bonded to the outer paper layer (as shown in FIGS. 9 and 10) with a low density resin applied with a laminator 124. The three-layer blank 128 (inner poly-woven layer, middle paper layer (with windows) and outer EVA layer) are wound onto a rewind roll 130 for further processing (tube and bag formation as described previously).

As detailed above with reference to the embodiment of bag 10 illustrated in FIGS. 2 and 3, the lateral edges of the three layers defining bag 100 may overlapped or offset relative to one another during seam formation as is known in the art.

Another alternate method for fabricating a three-layer blank web 128 is shown in FIG. 12. There, the two-layer blank 132, comprising the outer paper layer and the inner poly-woven ply (the outer layer being preprinted with indicia 46 and precut with windows 22, both of which are registered relative to one another) is supplied from a supply roll 134. Coating layer 136 (EVA or OPP or the like) is similarly supplied from a supply roll 138. Two-layer blank 132 and coating layer 136 are fed through a nip 140 defined between heated pinch rolls 142, 144 to bond the two layers together. In the illustration of FIG. 12, one or both of the inner layers and outer layers may be pre-coated on the surface that mates with the opposite layer with a suitable adhesive such as a heat-activated resin. It will be appreciated that the written indicia may be provided on the outer paper layer, and that the layers are registered relative to one another so that the window 22 and the printed indicia are always consistently located on each finished bag. In the illustration of FIG. 12 the woven fabric is not shown through windows 22 in the bonded multi-layer blank that is being wound onto the rewind roll.

Finally, in FIG. 13 the outer EVA layer 150 is preprinted with indicia 46. The printed EVA material is then registered with and laminated to the paper layer to define a two-layer supply roll 153. The poly-woven scrim 154 is supplied on roll 156. The materials supplied from the two supply rolls 153 and 156 are fed through a nip 158 between heated press rolls 160 and 162 to bond the layers together, and the three layer web 164 is taken up on a take up roll 166 for further processing as described above. It is important that when the EVA layer, which has been preprinted with indicia 46 is laminated to the paper layer, which has a die cut window 22, that the two layers are registered so that the window is always in the same position relative to the printing on each bag.

Finally, one further alternative processing method is to laminate a paper layer (without a window) to a preprinted EVA sheet, then die cut a window through the two-layer sheet thus formed (the die cut window is registered relative to the printed indicia), and then laminate the scrim layer to form a three-layer sheet. The three-layer sheet is then formed into finished bags in the manner described above.

While the present invention has been described in terms of a preferred embodiment, it will be appreciated by one of ordinary skill that the spirit and scope of the invention is not limited to those embodiments, but extend to the various modifications and equivalents as defined in the appended claims.

I claim:

1. A multi-layer bag for containing bulk quantities of material, comprising:
a first layer comprising transparent poly-woven fabric; and
a second paper layer having at least one window opening cut therein.

2. The bag of claim 1 wherein a bulk quantity of material contained within the bag may be visually discerned through said window.

3. The bag of claim 2 including a bag top edge, bottom edge, opposed lateral side edges defining a bag front panel and a bag back panel, and wherein at least one window opening is registered relative to the top and bottom edges so that the window opening is positioned in a desired position on the front panel between the top and bottom edges.

4. The bag of claim 3 including more than one window opening cut into the paper layer and registered relative to the top and bottom edges so that each window opening is positioned in a desired position on the front panel between the top and bottom edges.

5. The bag of claim 2 including written indicia on the front panel, and wherein the window opening is registered relative to the written indicia so that the window opening is in a desired position on the front panel relative to the written indicia.

6. The bag of claim 1 wherein the poly-woven fabric has a weight in the range of about 500 to about 1200 denier and a weave within the range of about 4 by 4 to about 15 by 15.

7. The bag of claim 1 wherein the poly-woven fabric has a weight in the range of about 800 to 900 denier and a weave of about 8 by 8.

8. The bag of claim 1 including a layer of transparent material overlying the paper layer.

9. The bag of claim 8 wherein the transparent layer is an EVA layer.

10. The bag of claim 8 wherein the transparent layer is an OPP layer.

11. The bag of claim 1 wherein the poly-woven fabric is a polypropylene fabric.

12. The bag of claim 1 wherein the poly-woven fabric is a polyethylene fabric.

13. The bag of claim 1 wherein the first layer defines the interior layer of the bag.

14. The bag of claim 1 wherein the first layer defines the exterior layer of the bag.

15. A method of forming a multi-layer bulk material bag comprising the steps of:
(a) providing a supply of paper;
(b) providing a supply of poly-woven fabric having a desired transparency;
(c) cutting a window opening in the paper;
(d) bonding the paper to the woven polypropylene fabric to form a multi-layer web;
(e) forming the web into a tube having a longitudinal axis and having opposed side edges and a front surface and a back surface;
(f) cutting the tube transverse to the longitudinal axis to form bags having open opposite ends; and
(g) closing one of the ends.

16. The method of claim 15 including the step of registering the window opening in the paper relative to the cutting of step (f) so that the window opening is positioned in substantially the same place on each bag.

17. The method of claim 16 including the step of printing indicia on the paper.

18. The method of claim 17 including the step of registering the position of the cut window opening relative to the printed indicia.

19. The method of claim 15 including prior to step (e) providing a supply of EVA and bonding the EVA to the paper layer.

20. The method of claim 19 including printing the EVA with written indicia and registering the printed indicia relative to the window so that the window is placed in the same position relative to the written indicia on each bag.

21. A multi-layer bag for containing bulk quantities of material, comprising:
an outer paper layer formed into a tube having an outer surface and an inner surface, the tube having one closed end, and said paper layer including at least one window opening cut therein and printed indicia thereon registered relative to the window;
an inner layer of poly-woven fabric bonded to the inner surface of the paper layer over substantially the entire inner surface thereof, said poly-woven fabric having sufficient transparency that a bulk quantity of material within said bag may be visually inspected through said window.

22. The bag of claim 21 including a bag top edge, bottom edge, opposed lateral side edges defining a bag front panel and a bag back panel, and wherein at least one window opening is registered relative to the top and bottom edges so that the window opening is positioned in a desired position on the front panel between the top and bottom edges.

23. The bag of claim 22 including more than one window opening cut into the outer paper layer and registered relative to the top and bottom edges so that each window opening is positioned in a desired position on the front panel between the top and bottom edges.

24. The bag of claim 21 wherein the poly-woven fabric has a weight in the range of about 800 to 900 denier and a weave of about 8 by 8.
